(19) United States
(12) Patent Application Publication
(10) Pub. No.: US 2018/0339577 A1
(43) Pub. Date: Nov. 29, 2018

(54) Roof roller blind system for a motor vehicle and method for mounting a roof roller blind system for a motor vehicle

(71) Applicant: Roof Systems Germany GmbH, Dietzenbach (DE)

(72) Inventors: Franz Adelmann, Offenbach (DE); Daniel Poppe, Elsenfeld (DE); Kai Stehning, Frankfurt (DE)

(21) Appl. No.: 15/982,472

(22) Filed: May 17, 2018

(30) Foreign Application Priority Data
May 17, 2017 (DE) 10 2017 110 746.0

(51) Int. Cl. B60J 7/00; B60J 1/20

(52) U.S. Cl. CPC B60J 7/0015; B60J 1/2033; B60J 1/2063

(57) ABSTRACT

A roof roller blind system for a motor vehicle, having a spring cartridge and a winding shaft is described, wherein the winding shaft comprises a non-circular inner cross-section, wherein an end portion of the spring cartridge contacts the inner cross-section of the winding shaft at least in portions in a torque-transmitting manner. A method for mounting a roof roller blind system for a motor vehicle is also described.

### CROSS REFERENCE TO RELATED APPLICATIONS

This application claims priority under 35 U.S.C. § 119 to following German Patent application no. DE 10 2017 110 746.0, filed on May 17, 2017, the entire contents of which are incorporated herein by reference thereto.

### TECHNICAL FIELD

The invention relates to a roof roller blind system for a motor vehicle and to a method for mounting a roof roller blind system for a motor vehicle.

### BACKGROUND

Roof roller blind systems with a spring drive and a winding shaft with fabric attached thereto are known from the prior art. Typically, the spring motor is connected at two ends to a respective holder of the roof roller blind system.

The mounting of such roof roller blind systems requires considerable effort since during mounting of the system both ends of a pretensioned spring motor must be secured against rotation.

### BRIEF SUMMARY

It is therefore the object of the invention to provide a roof roller blind system which is easy to mount.

This object is achieved in accordance with the invention by a roof roller blind system for a motor vehicle having a spring cartridge and a winding shaft, wherein the winding shaft comprises a non-circular inner cross-section, wherein an end portion of the spring cartridge contacts the inner cross-section of the winding shaft at least in portions in a torque-transmitting manner. In this way, the spring cartridge is connected at one of its ends to the winding shaft for conjoint rotation therewith. A torque exerted on the winding shaft (e.g. when the roof roller blind system is being extended) can thereby be transferred directly from the winding shaft to the spring cartridge. Extended means that fabric is being unrolled from the winding shaft, whereby, in particular, the entry of sunlight into the interior of the motor vehicle through a roof opening of said motor vehicle is reduced. In this manner, a retracting moment of the spring cartridge is also transferred directly to the winding shaft. During mounting of the roof roller blind system, one end of the spring cartridge must still be secured against rotation relative to the winding shaft.

The spring cartridge preferably has a widening in the region of the end portion, which widening is directly connected to the inner cross-section of the winding shaft in a torque-transmitting manner. In particular, the widening is integrally formed as one piece on the spring cartridge. A torque exerted on the winding shaft can thus be transferred particularly well to the spring cartridge. In this manner a retracting moment of the spring cartridge can also be transferred particularly well to the winding shaft.

Provision is also preferably made that there is a form-fitting connection between the widening of the end portion of the spring cartridge and the inner cross-section of the winding shaft, as seen in the peripheral direction. In this way, the connection has little play, whereby annoying noises during a change in rotational direction of the winding shaft are reduced.

One aspect of the invention makes provision that the spring cartridge comprises an inner rod, a first spring entrainer, a second spring entrainer and a spring, wherein end portions of the spring are pushed onto a respective spring entrainer and the spring entrainers are coupled to the inner rod. The spring cartridge thus forms a pre-mountable construction unit. This construction unit can then be used in different roof roller blind systems. The inner rod prevents the spring from turning over in the event of excessive rotational tensioning.

According to a further aspect, the first spring entrainer and the second spring entrainer are connected to the inner rod in such a way that the first spring entrainer and the second spring entrainer can rotate relative to one another. In this way, the spring can absorb turning moments acting on the spring entrainers and store the resulting potential energy.

Preferably at least one of the spring entrainers has grooves on its outer periphery, which are complementary to windings of an end portion of the spring. In this way, the spring is connected in one rotational direction in a form-fitting manner to the spring entrainer for conjoint rotation therewith without the spring having to be specially formed or bent. This is advantageous since, during bending of spring wire, weak points can be produced in the spring wire which can break when transferring forces. In other words, the torque can be transferred in a particularly reliable manner from and to the spring. If the spring is pretensioned in the wrong direction, it jumps off the spring entrainer without thereby being destroyed. Furthermore, the spring is connected to the at least one spring entrainer so as also to be non-displaceable thereby in the axial direction of the spring until a limit force is reached.

A further aspect makes provision that a widening is provided on the second spring entrainer and serves to transfer a torque to the winding shaft. A torque acting on the winding shaft is thus transferred to the spring via the second spring entrainer. A retracting moment of the spring is likewise transferred to the winding shaft via the two spring entrainers.

In a further embodiment of the invention, the spring cartridge comprises a tensioning device, wherein the tensioning device is provided at an end which is opposite to the end portion which contacts the inner cross-section of the winding shaft in a torque-transmitting manner. By means of the tensioning device, pretensioning of the spring cartridge can easily be adapted to the respective roof roller blind model.

According to one aspect of the invention provision is made that an outer end portion of the tensioning device has an outer cross-section in the form of a simple polygon, in particular a quadrilateral. In this way, the tensioning device can be secured against rotation in a particularly simple manner in that it is inserted into a depression, the inner cross-section of which is engaged by the outer cross-section.

The tensioning device is preferably provided on the first spring entrainer. In particular, the first spring entrainer and the winding shaft can rotate relative to one another. In this way, the spring can also be pretensioned after the spring cartridge has been inserted into the winding shaft.

In one embodiment of the invention, an anti-rotation device is provided at at least one end of the winding shaft and can be attached to the at least one end of the winding shaft in such a way that the anti-rotation device and the winding shaft are connected for conjoint rotation. In particular, the anti-rotation device and the winding shaft are connected to one another in a form-fitting manner for conjoint rotation. By means of the anti-rotation device the winding shaft can thus thereby be secured against rotation about its longitudinal axis.

The winding shaft can comprise at least one recess at at least one end, into which recess a lug—which is complementary to the recess—on the anti-rotation device engages. In particular, the lug can be designed in such a way that the anti-rotation device and the winding shaft are also fixedly connected in the axial direction of the winding shaft.

A respective depression is preferably provided on an inner side of the anti-rotation device and on an outer side of the tensioning device. Owing to the fact that the depressions are positioned in an opposing arrangement and e.g. a wire pin is inserted into the depressions, the anti-rotation device and the tensioning device can be secured against a relative rotational movement.

According to one embodiment of the invention, a fabric strip is attached to the winding shaft. The fabric strip can be rolled on the winding shaft. In particular, the fabric strip can be rolled on the winding shaft even prior to mounting of the roof roller blind system.

According to a further embodiment of the invention, the fabric strip has a synthetic material reinforcement on at least portions of its periphery, wherein the fabric strip is attached to the winding shaft by thermowelding. The fabric strip can thus be attached to the winding shaft in a particularly simple manner.

A further aspect makes provision that the spring cartridge extends over 30-90 percent of the length of the winding shaft, preferably over 40-80 percent, more preferably over 50-70 percent. The spring cartridge thus does not have to extend over the whole length of the winding shaft, whereby the spring cartridge is universally usable for different winding shaft lengths.

The object is further achieved in accordance with the invention by a method for mounting a roof roller blind system for a motor vehicle, comprising the following steps:
mounting the spring cartridge;
pushing the spring cartridge into the winding shaft;
pretensioning the spring cartridge;
securing the winding shaft and the spring cartridge against rotation;
installing the assembly consisting of a winding shaft and spring cartridge into the roof roller blind system; and
releasing the securing of the winding shaft and of the spring cartridge against rotation.

The advantage of the method in accordance with the invention is that a spring cartridge universally usable for different winding shaft lengths is simply pushed into the winding shaft and the pretensioning of the spring can be adapted to the respective roof roller blind system in a particularly simple manner by rotating the tensioning device. In addition, mounting is facilitated since it is necessary to secure the winding shaft and the spring cartridge against relative rotational movement only at one end of the winding shaft.

With respect to the other advantages, reference is made to the explanatory statements given above.

A fabric strip is preferably attached to the winding shaft, in particular by thermowelding, before the spring cartridge is pushed into the winding shaft. The winding shaft, fabric strip and spring cartridge can then be installed into the roof roller blind system as a premounted unit.

### BRIEF DESCRIPTION OF THE DRAWINGS

Further advantages and properties of the invention will be apparent from the following description and the drawings to which reference is made and in which:

FIG. 1 is a longitudinal cross-sectional view through an end portion of a roof roller blind system in accordance with the invention;

FIG. 2 is a perspective view of a spring cartridge of the roof roller blind system in accordance with the invention of FIG. 1;

FIG. 3 is a detailed view of an end portion of the spring cartridge of FIG. 2;

FIG. 4 shows an assembly for the roof roller blind system in accordance with the invention of FIG. 1;

FIG. 5 is a detailed view of an end of the assembly of FIG. 4;

FIG. 6 is a perspective view of the end portion of the roof roller blind system in accordance with the invention of FIG. 1; and

FIG. 7 is a perspective view of an end portion of the roof roller blind system opposite the end portion illustrated in FIG. 6.

### DETAILED DESCRIPTION

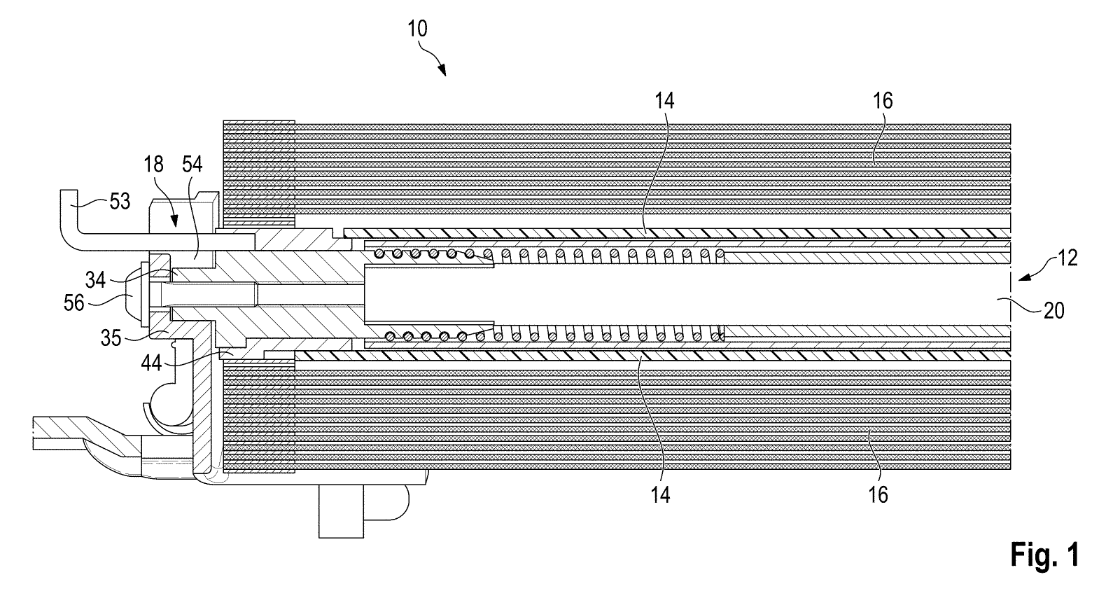

FIG. 1 is a longitudinal cross-sectional view through an end portion of a roof roller blind system 10.

The roof roller blind system 10 serves as a sun blind of a sliding roof system of a motor vehicle. The roof roller blind system 10 thus serves in particular to reduce sunlight entering through a roof opening of the motor vehicle into the interior of the motor vehicle.

The roof roller blind system 10 comprises a spring cartridge 12, a winding shaft 14 made from synthetic material with a fabric strip 16 attached thereto and a holder 18.

The structure of the spring cartridge 12 is explained in more detail hereinunder with the aid of FIGS. 1 to 3.

The spring cartridge 12 comprises an inner rod 20, a first spring entrainer 22 attached to the inner rod 20, a second spring entrainer 24 attached to the inner rod 20 and a spring 26.

The spring 26 is in this case formed as a coil spring and is located on the inner rod 20. A spring wire thickness for the spring 26 can be between 0.6 mm and 1.2 mm, in particular between 0.7 mm and 1.1 mm, e.g. 0.8 mm to 0.9 mm.

A respective end portion of the spring 26 is pushed onto one of the spring entrainers 22, 24. The spring entrainers 22, 24 in this case each have grooves 28 on their outer periphery, which grooves are complementary to the respective end portion of the spring 26. In this way, the spring 26 is connected in a form-fitting manner to the spring entrainers 22, 24 for conjoint rotation in a respective rotational direction.

The spring entrainers 22, 24 are attached to the inner rod 20 in such a way that they can rotate relative to one another, wherein the inner rod 20 keeps the two spring entrainers 22, 24 at a distance apart.

A non-circular, in this case cog-like, widening 30 is attached to the second spring entrainer 24, in particular is connected as one piece to the second spring entrainer 24.

A tensioning device 34 is provided on the first spring entrainer 22, wherein the tensioning device 34 is attached to the first spring entrainer 22 for conjoint rotation therewith. The spring 26 can be pretensioned in that the tensioning device 34 is rotated. An outer cross-section 35 of the tensioning device 34 is in this case formed as a quadrilateral, in particular a square. However, the outer cross-section 35 can also be in the shape of another simple polygon.

The tensioning device 34 further comprises a central bore 36. By means of the bore 36, the spring cartridge 12 can be attached to the roof roller blind system 10, e.g. by means of a bearing pin.

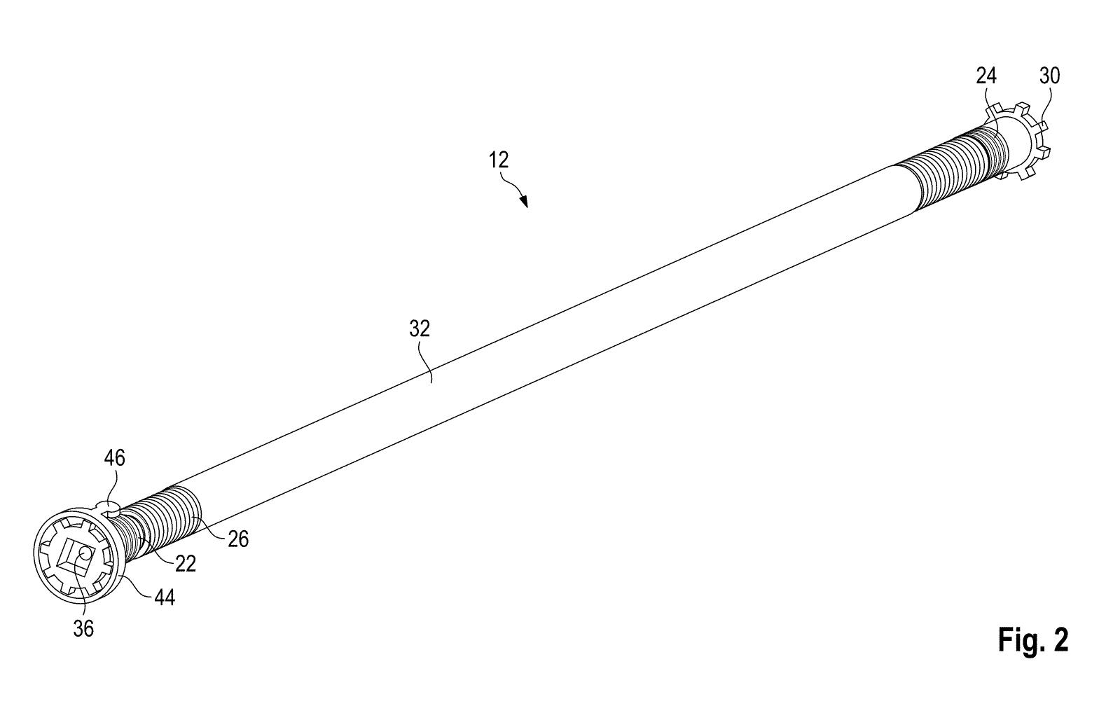

As shown particularly clearly by FIG. 2, the spring 26 can optionally have a casing 32 at least in portions, said casing being made of synthetic material, in particular polyethylene. In this way, noise generated when the spring 26 impacts components located outside the spring 26 is damped.

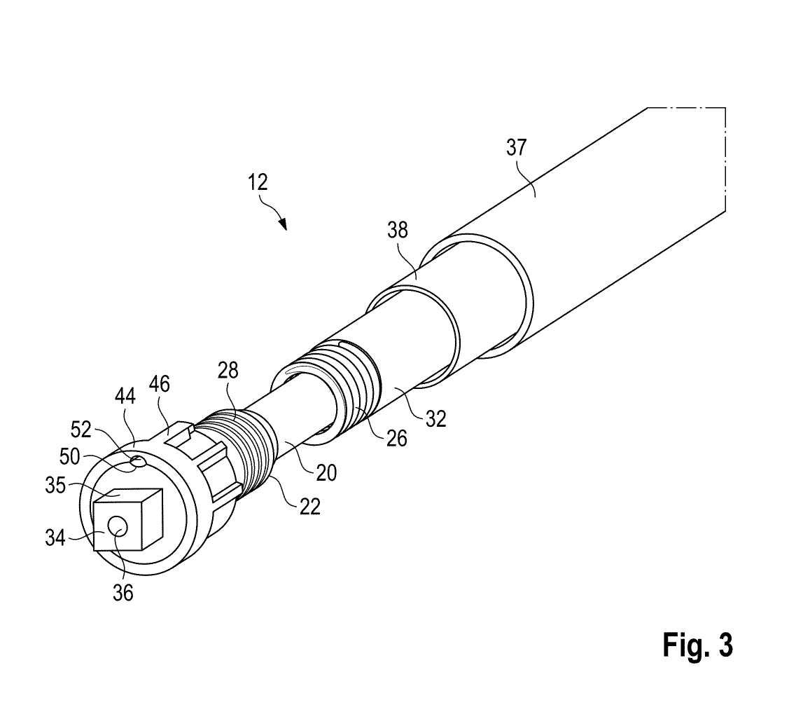

Furthermore, as shown in FIG. 3, the spring cartridge 12 can also comprise an outer pipe 37, wherein in particular a film 38 can be provided between the spring 26 and the outer pipe 37.

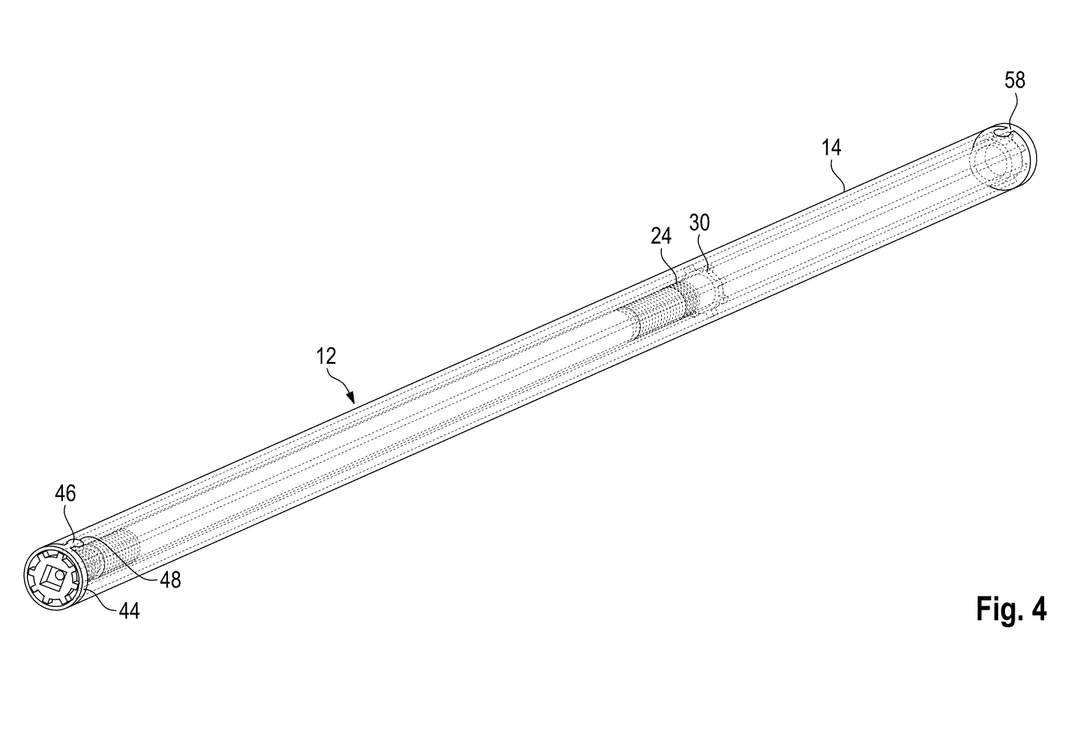

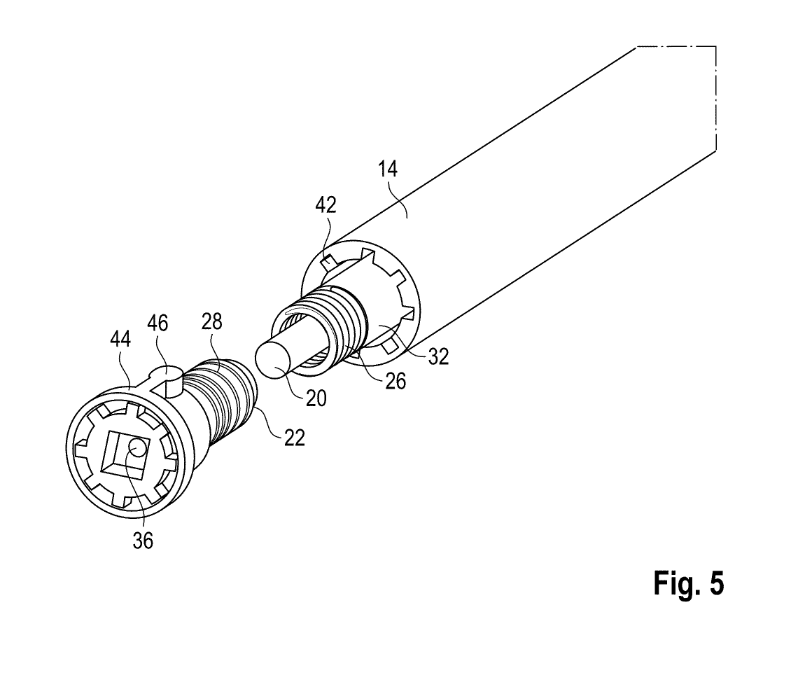

FIGS. 4 and 5 show a winding shaft 14 with a spring cartridge 12 pushed therein, wherein FIG. 5 illustrates the spring cartridge 12 with the first spring entrainer 22 detached for improved clarity.

The spring cartridge 12 in this case extends over about 65 percent of the length of the winding shaft 14. However, it is also possible for the spring cartridge to extend over 30 to 90 percent of the length of the winding shaft 14. In other words, the spring cartridge 12 forms a spring drive which is universally usable for different winding shaft lengths.

The winding shaft 14 has an non-circular inner cross-section 42 into which the widening 30 on the second spring entrainer 24 engages at least in portions in a torque-transmitting manner. By means of the second spring entrainer 24 and the widening 30, the spring 26—as viewed in the peripheral direction—is connected to the winding shaft 14 in a form-fitting, torque-transmitting manner.

In the embodiment illustrated in this case, the inner cross-section 42 is substantially complementary to the widening 30.

At at least one end of the winding shaft 14 an anti-rotation device 44 is attached to the winding shaft 14 for conjoint rotation therewith. The anti-rotation device 44 comprises a lug 46 which engages into a corresponding recess 48 in the winding shaft 14 to form a form-fitting connection for conjoint rotation.

As shown particularly clearly in FIG. 3, the tensioning device 34, on its outer side, and the anti-rotation device 44, on its inner side, have a respective depression 50, 52.

The fabric strip 16 (not shown for the sake of clarity in FIGS. 2 to 7) is attached to an outer side of the winding shaft 14. The fabric strip 16 comprises a synthetic material reinforcement, at least in portions, on its periphery, wherein the fabric strip can be attached to the winding shaft 14 by thermowelding of the synthetic material reinforcement and the winding shaft 14.

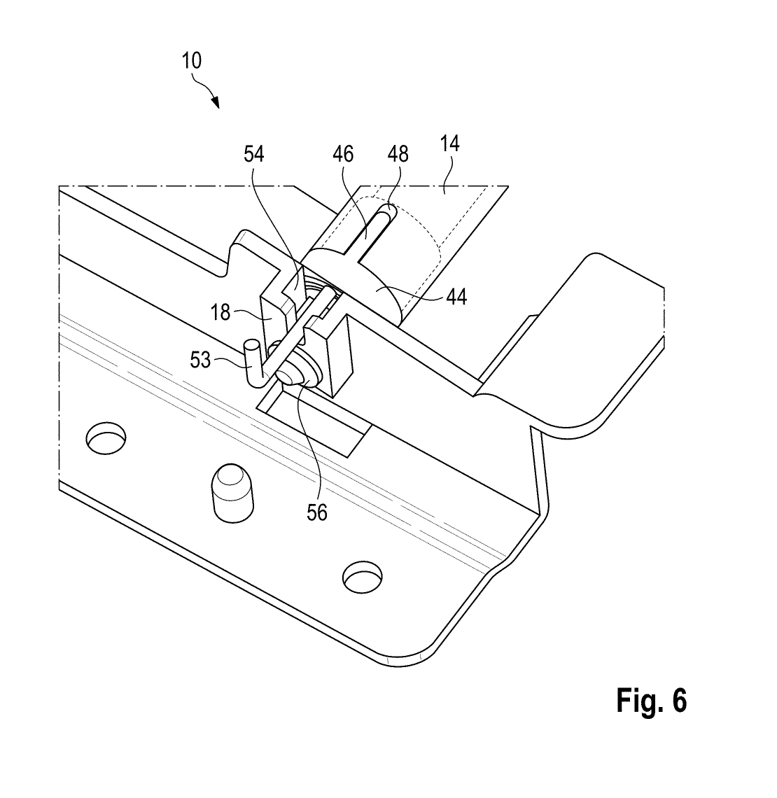

FIG. 6 shows an inclined view of the holder 18 and of an assembly consisting of a winding shaft 14 and spring cartridge 12. The holder 18 comprises an anti-rotation portion 54 which is designed in such a way that the tensioning device 34 engages with its outer cross-section 35 in a form-fitting manner into the inner cross-section of the anti-rotation portion 54 for conjoint rotation therewith. In the embodiment illustrated in this case, the anti-rotation portion 54 is formed as a cuboid into which the tensioning device 34 can be inserted in a form-fitting manner for conjoint rotation therewith.

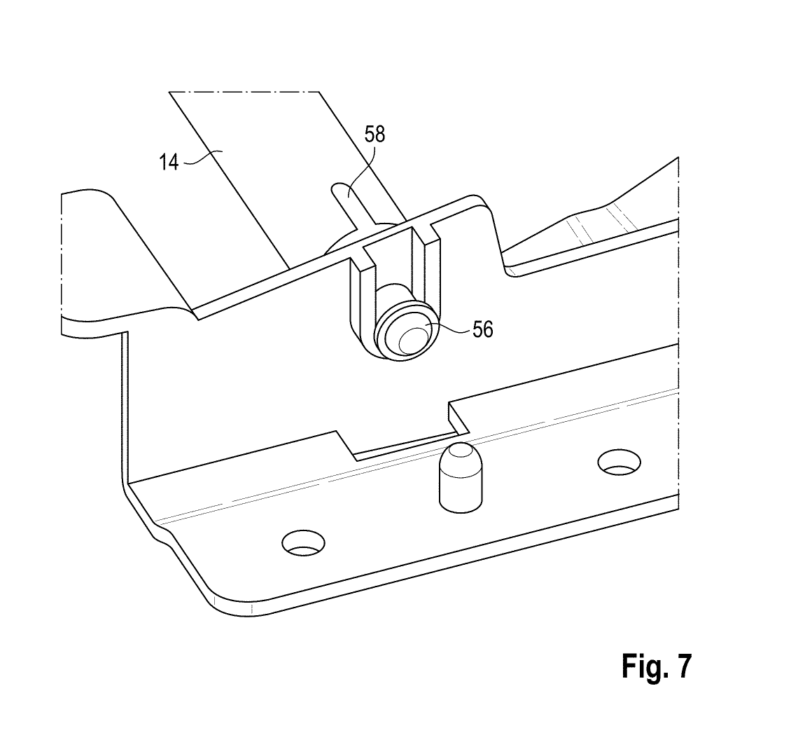

FIG. 7 shows an end portion of the assembly consisting of a winding shaft 14 and spring cartridge 12, which is opposite the end portion shown in FIG. 6. The assembly consisting of a winding shaft 14 and spring cartridge 12 is in this case rotatably attached to the roof roller blind system 10 by means of a bearing pin 56 via a connecting element 58.

A method for mounting the roof roller blind system 10 is explained hereinunder.

The spring cartridge 12 is mounted first. For this purpose, the spring 26 is pushed onto the inner rod 20 and the spring entrainers 22, 24 are attached to the inner rod 20. Ends of the spring 26 are now pushed onto a respective one of the spring entrainers 22, 24.

Furthermore, the fabric strip 16 is attached to the winding shaft 14 by thermowelding and wound thereon.

The premounted spring cartridge 12 is now pushed into the winding shaft 14.

The spring 26 of the spring cartridge 12 is then pretensioned in that the tensioning device 34 is rotated. If a desired level of pretensioning is achieved, the depressions 50, 52 of the tensioning device 34 and of the anti-rotation device 44 are positioned opposite one another.

The anti-rotation device 44 and the tensioning device 34 are now secured against a relative rotational movement. This takes place e.g. in that, as shown in FIG. 1, a blocking element 53, in particular a wire pin, is inserted into the depressions 50, 52. By means of a form-fitting arrangement this prevents relative rotational movement of the anti-rotation device 44 and tensioning device 34. Since the anti-rotation device 44 and the winding shaft 14 are connected for conjoint rotation, the tensioning device 34 and the winding shaft 14 are therefore also secured against a relative rotational movement.

The assembly consisting of a winding shaft 14 and spring cartridge 12 is now inserted into the holder 18, whereby the tensioning device 34 lies in a form-fitting manner against the anti-rotation portion 54 for conjoint rotation therewith. A retracting moment which the spring 26 exerts onto the winding shaft 14 can thereby be supported against the anti-rotation portion 54.

Both ends of the assembly consisting of a winding shaft 14 and spring cartridge 12 are fastened, e.g. by means of bearing pins 56 which can be formed as common parts, in particular at both ends.

The securing of the winding shaft 14 and of the spring cartridge 12 against rotation is now released. In the example shown in this case, the blocking element 53 is for this purpose removed from the depressions 50, 52.

Alternatively, the securing of the winding shaft 14 and of the spring cartridge 12 against rotation can also even be released after the assembly consisting of the winding shaft 14 and spring cartridge 12 is inserted into the holder, i.e. even before the assembly consisting of the winding shaft 14 and spring cartridge 12 is fastened by means of the bearing pin 56.

1. A roof roller blind system for a motor vehicle, having a spring cartridge and a winding shaft, wherein the winding shaft comprises a non-circular inner cross-section, wherein an end portion of the spring cartridge contacts the inner cross-section of the winding shaft at least in portions in a torque-transmitting manner.

2. The roof roller blind system as claimed in claim 1, wherein the spring cartridge has a widening in the region of the end portion, which widening is connected to the inner cross-section of the winding shaft in a torque-transmitting manner.

3. The roof roller blind system as claimed in claim 2, wherein there is a form-fitting connection between the widening of the end portion of the spring cartridge and the inner cross-section of the winding shaft, as seen in the peripheral direction.

4. The roof roller blind system as claimed in claim 1, wherein the spring cartridge comprises an inner rod, a first spring entrainer, a second spring entrainer and a spring, wherein end portions of the spring are pushed onto a respective spring entrainer and the spring entrainers are coupled to the inner rod.

5. The roof roller blind system as claimed in claim 4, wherein the first spring entrainer and the second spring entrainer are connected to the inner rod in such a way that the first spring entrainer and the second spring entrainer can rotate relative to one another.

6. The roof roller blind system as claimed in claim 4, wherein at least one of the spring entrainers comprises grooves on its outer periphery, which grooves are complementary to windings of an end portion of the spring.

7. The roof roller blind system as claimed in claim 4, wherein a widening is provided on the second spring entrainer and serves to transfer a torque to the winding shaft.

8. The roof roller blind system as claimed in claim 1, wherein the spring cartridge comprises a tensioning device, wherein the tensioning device is provided at an end which is opposite to the end portion which contacts the inner cross-section of the winding shaft in a torque-transmitting manner.

9. The roof roller blind system as claimed in claim 8, wherein an outer end portion of the tensioning device has an outer cross-section in the form of a simple polygon, in particular a quadrilateral.

10. The roof roller blind system as claimed in claim 4, wherein the spring cartridge comprises a tensioning device, the tensioning device being provided at an end which is opposite to the end portion which contacts the inner cross-section of the winding shaft in a torque-transmitting manner, and wherein the tensioning device is provided on the first spring entrainer.

11. The roof roller blind system as claimed in claim 1, wherein an anti-rotation device is provided at at least one end of the winding shaft and can be attached to the at least one end of the winding shaft in such a way that the anti-rotation device and the winding shaft are connected for conjoint rotation.

12. The roof roller blind system as claimed in claim 11, wherein the winding shaft comprises at least one recess at at least one end, into which recess a lug that is complementary to the recess on the anti-rotation device engages.

13. The roof roller blind system as claimed in claim 8, wherein an anti-rotation device is provided at at least one end of the winding shaft and can be attached to the at least one end of the winding shaft in such a way that the anti-rotation device and the winding shaft are connected for conjoint rotation and wherein a respective depression is provided on an inner side of the anti-rotation device and on an outer side of the tensioning device.

14. The roof roller blind system as claimed in claim 1, wherein a fabric strip is attached to the winding shaft.

15. The roof roller blind system as claimed in claim 14, wherein the fabric strip has a synthetic material reinforcement on at least portions of its periphery, wherein the fabric strip is attached to the winding shaft by thermowelding.

16. The roof roller blind system as claimed in claim 1, wherein the spring cartridge extends over 30-90 percent of the length of the winding shaft, preferably over 40-80 percent, more preferably over 50-70 percent.

17. A method for mounting a roof roller blind system as claimed in claim 1 comprising the following steps:
mounting the spring cartridge;
pushing the spring cartridge into the winding shaft;
pretensioning the spring cartridge;
securing the winding shaft and the spring cartridge against rotation;
installing the assembly consisting of a winding shaft and spring cartridge into the roof roller blind system; and
releasing the securing of the winding shaft and of the spring cartridge against rotation.

18. The method for mounting a roof roller blind system as claimed in claim 17, wherein a fabric strip is attached to the winding shaft, in particular by thermowelding, before the spring cartridge is pushed into the winding shaft.

19. The roof roller blind system as claimed in claim 2, wherein the spring cartridge comprises an inner rod, a first spring entrainer, a second spring entrainer and a spring, wherein end portions of the spring are pushed onto a respective spring entrainer and the spring entrainers are coupled to the inner rod.

20. The roof roller blind system as claimed in claim 19, wherein the first spring entrainer and the second spring entrainer are connected to the inner rod in such a way that the first spring entrainer and the second spring entrainer can rotate relative to one another.
